(19) United States
(12) Patent Application Publication
(10) Pub. No.: US 2024/0184055 A1
(43) Pub. Date: Jun. 6, 2024

(54) LASER WELDING OF OPTICAL FIBERS TO SUBSTRATES

(71) Applicant: CORNING RESEARCH & DEVELOPMENT CORPORATION, CORNING, NY (US)

(72) Inventors: Tim Grygiel, Schoenebeck (DE); Andreas Matiss, Berlin (DE)

(21) Appl. No.: 18/387,581

(22) Filed: Nov. 7, 2023

Related U.S. Application Data
(60) Provisional application No. 63/430,652, filed on Dec. 6, 2022.

(51) Int. Cl. G02B 6/36; B23K 26/03; B23K 26/0622

(52) U.S. Cl. CPC G02B 6/3628; B23K 26/032; B23K 26/0622

(57) ABSTRACT

A system for laser welding a fiber to a substrate is provided. The system comprises a fiber having a first end, a substrate defining a surface, a coating, a laser configured to emit photonic energy, one or more processors, and memory. The memory includes computer readable code configured to, when executed, cause the processor(s) to perform various tasks. The tasks include positioning the fiber relative to the substrate so that the first end of the fiber is positioned proximate to the surface of the substrate with the coating positioned between the fiber and the substrate. The tasks also include positioning the laser relative to the fiber or the substrate. The tasks also include causing the laser to emit photonic energy through the fiber or through the substrate. Emission of the photonic energy through the fiber or through the substrate causes the fiber to be laser welded to the substrate.

### PRIORITY CLAIM

This application claims the benefit of priority of U.S. Provisional Application Ser. No. 63/430,652 filed on Dec. 6, 2022, the content of which is relied upon and incorporated herein by reference in its entirety.

### FIELD

Embodiments relate generally to laser welding of fibers to substrates.

### BACKGROUND

In attempting to directly bond fibers to photonics devices, some have attempted to use fiber splicing approaches using electrical arc or carbon dioxide (CO₂) lasers. However, these approaches each have their own shortcomings. These approaches are not able to effectively bond fiber to different shaped optical components, and these approaches face several challenges in attempting to form high density interfaces.

Additionally, conventional multi-push connectors often are insufficient to meet the requirements for higher density applications like data centers. One-dimensional connectors exist which rely on V-grooves and ferruled fibers used to support these applications, but two-dimensional arrays are a much bigger challenge. Typically, to provide precise alignment, one must drill holes in a lens substrate and place fiber in each one of the holes, but this technique faces challenges in scaling up arrays to large fiber counts.

Others have attempted to use carbon dioxide (CO₂) lasers, with fiber being aligned against them one-by-one and welded using a CO₂ laser. While this approach is capable of making large count two-dimensional arrays, this CO₂ laser approach has drawbacks as well. Currently available CO₂ lasers are only capable of acting at the side of a fiber at an angle relative to a central axis extending through the fiber, and this is due to a high absorption coefficient of fibers and glass surfaces. This makes laser welding using CO₂ lasers challenging for multiple reasons. First, this is challenging due to shadowing by neighbor fibers. Second, laser welding using CO₂ lasers is challenging due to non-uniform heating of the fiber and substrate interface due to angled excitation. With this non-uniform heating, some locations on the fiber tend to overheat.

Additionally, ultrafast laser approaches are possible in principle, but these approaches currently have many limitations. With ultrafast laser approaches, surfaces of the fiber and photonic device must be in very tight contact with each other, with a gap between surfaces being between 0.1 microns and 0.2 microns, and minimal distortion of the pulse duration must be present through the delivery path. It is also important for ultrafast laser approaches to maintain focusing or spot sizes since these approaches are very sensitive to power density. Ultrafast laser approaches are challenging when attempting to focus beams through non-flat elements like lens arrays and other similar components.

### SUMMARY

In various embodiments, a laser welding approach is used to attach fibers to substrates. In some embodiments, the fibers generally extend orthogonally relative to the substrate. The fiber is directly welded to a substrate using an ultraviolet laser and absorbing coating on surface of the lens. In this regard, a coating material is positioned on the substrate. One or more lasers may be used to emit photonic energy through the fiber and/or substrate, with photonic energy from the laser providing, for example, uniform symmetrical heating of the interface (e.g., the coating) between the fiber and the substrate. The coating material on the substrate may thus dissolve into the substrate after sufficient photonic energy is emitted, and the coating material may become transparent at the relevant wavelength of the laser(s).

One or more lasers may be used to emit photonic energy through the fiber and/or the substrate so that photonic energy reaches coating positioned between the fiber and the substrate. This is different from approaches using CO₂ lasers, which deliver photonic energy from the sides as described above. By emitting photonic energy through the fiber and/or the substrate, welding may be performed with more uniformity and with less distortion in the fiber.

Additionally, laser welding approaches described herein may attach a fiber to a substrate without any epoxy or organic adhesive in an optical path for the fiber. As a result, several advantages may be obtained. First, the process of attaching a fiber to another substrate may be a faster process. Second, attaching a fiber to a substrate may result in less degradation. Third, attaching a fiber to another substrate may be accomplished without issues in the return signal as back-reflection signals may be minimized. Fourth, better environmental stability may be accomplished. Additional advantages include the ability to accomplish higher fiber densities, greater complexity, and improved reliability.

Additionally, while ultrafast laser approaches required tight contact between surfaces and minimal distortion of pulse duration through the delivery path, pulsed ultraviolet laser welding approaches may be used to remove these limitations, especially where pulses are only nanoseconds in length and where metal or other inorganic surface materials are used. With these pulsed ultraviolet laser welding approaches, the amount of distortion of the fiber and the materials that the fiber is attached to due to welding process is minimal. Additionally, with these pulsed ultraviolet laser welding approaches, the effect of the laser processed coating on the glass surface is minimal. This pulsed ultraviolet laser welding approach may be extended to bond optical fibers orthogonally to a broad range of substrates. For example, fibers may be bonded to glass substrates comprising silica or some other material, and fibers may be bonded to substrates in the form of a lens arrays, single focusing lenses, C-lenses, or other optical elements. With the laser welding approaches described herein, any dissolved coating material has little or no effect on attenuation, and a low insertion loss may be accomplished due to dissipation of the absorbing coating used for starting the process. Laser welding approaches described herein may be used to complete fiber collimation in many different micro-optics devices.

In an example embodiment, a method for laser welding a fiber to a substrate is provided. The method comprises positioning a fiber relative to a substrate so that a first end of the fiber is positioned proximate to a surface of the substrate with a coating positioned between the fiber and the substrate. The method also comprises positioning a laser relative to the fiber or the substrate. Additionally, the method comprises causing the laser to emit photonic energy through the fiber or through the substrate. Emission of the photonic energy through the fiber or through the substrate causes the fiber to be laser welded to the substrate.

In some embodiments, the laser may be an ultraviolet laser. In some embodiments, emission of the photonic energy may cause the coating to dissolve into the substrate and to become transparent at the wavelength of the laser. In some embodiments the laser may be configured to generate photonic energy in pulses lasting about 10 nanoseconds or less.

In some embodiments, the fiber may have a second end, the laser may be positioned proximate to the second end of the fiber, and causing the laser to emit photonic energy through the fiber or through the substrate may be performed by emitting photonic energy from the laser to the second end of the fiber.

In some embodiments, the laser may be positioned proximate to the substrate, and causing the laser to emit photonic energy through the fiber or through the substrate may be performed by emitting photonic energy from the laser through the substrate so that the photonic energy then travels from the substrate to the first end of the fiber.

In some embodiments, the method also comprises utilizing a power meter to monitor whether the laser welding has been completed. Additionally, in some embodiments, the method may also comprise a second laser configured to emit feedback photonic energy, and the feedback photonic energy may be directed towards the coating so that at least a portion of the feedback photonic energy is redirected to the power meter.

In some embodiments, the method also comprises positioning at least one optical element so that the at least one optical element receives photonic energy from the laser and directs the photonic energy towards the fiber or the substrate. Additionally, in some embodiments, the at least one optical element may include at least one of a mirror, a lens, or a shutter.

In some embodiments, the fiber may also be configured to emit light out of the fiber and towards the substrate in an optical path, with no epoxies or organic adhesives being positioned within the optical path. In some embodiments, the substrate may have a material having a lower melting temperature than silica.

In some embodiments, the coating may be an inorganic thin coating having a thickness of less than about 100 nanometers. Additionally, in some embodiments, the coating may be configured to absorb the photonic energy at wavelength of the laser with at least about 30 percent absorption. Furthermore, in some embodiments, the coating may become transparent at the wavelength of the laser after activation of the laser.

In some embodiments, the coating may be a metal coating. Furthermore, the coating may comprise stainless steel or copper. In some embodiments, the fiber may be positioned relative to a substrate so that a primary axis of the fiber at the first end is orthogonal to the surface of the substrate.

In another example embodiment, a non-transitory computer readable medium for laser welding a fiber to a substrate is provided. The non-transitory computer readable medium has stored thereon software instructions that, when executed by one or more processors, cause the one or more processors to perform various tasks. The tasks include positioning a fiber relative to a substrate so that a first end of the fiber is positioned proximate to a surface of the substrate with a coating positioned between the fiber and the substrate. The tasks also include positioning a laser relative to the fiber or the substrate and causing the laser to emit photonic energy through the fiber or through the substrate. Emission of the photonic energy through the fiber or through the substrate causes the fiber to be laser welded to the substrate. In some embodiments, the coating may be an inorganic thin metal coating having a thickness of less than about 100 nanometers.

In another example embodiment, a system for laser welding a fiber to a substrate is provided. The system comprises a fiber having a first end, a substrate defining a surface, a coating, a laser configured to emit photonic energy, one or more processors, and memory. The memory includes computer readable code configured to, when executed, cause the one or more processors to perform various tasks. The tasks include positioning the fiber relative to the substrate so that the first end of the fiber is positioned proximate to the surface of the substrate with the coating positioned between the fiber and the substrate. The tasks also include positioning the laser relative to the fiber or the substrate and causing the laser to emit photonic energy through the fiber or through the substrate. Emission of the photonic energy through the fiber or through the substrate causes the fiber to be laser welded to the substrate.

In some embodiments, the laser may be an ultraviolet laser configured to generate photonic energy in pulses. In some embodiments, the coating may be an inorganic thin metal coating having a thickness of less than about 100 nanometers. In some embodiments, the fiber may be configured to emit light out of the fiber and towards the substrate in an optical path, with no epoxies or organic adhesives being positioned within the optical path.

In another example embodiment, a fiber assembly is provided that is made by a particular process. The process comprises positioning a fiber relative to a substrate so that a first end of the fiber is positioned proximate to a surface of the substrate with a coating positioned between the fiber and the substrate. The process also comprises positioning a laser relative to the fiber or the substrate and causing the laser to emit photonic energy through the fiber or through the substrate. Emission of the photonic energy through the fiber or through the substrate causes the fiber to be laser welded to the substrate.

### BRIEF DESCRIPTION OF THE DRAWINGS

Reference will now be made to the accompanying drawings, which are not necessarily drawn to scale, and wherein:

FIGS. 1A-1C are schematic views illustrating example systems for laser welding a fiber to a substrate, in accordance with some embodiments discussed herein;

FIG. 2 is a schematic view illustrating example fiber assemblies with photonic energy extending through either a fiber or a substrate in the form of a lens, in accordance with some embodiments discussed herein;

FIG. 3 is a schematic view illustrating example fiber assemblies with light extending through either a fiber or a substrate in the form of a lens array, in accordance with some embodiments discussed herein;

FIG. 4 is a perspective view illustrating an example fiber assembly once the fiber has been welded to a substrate, in accordance with some embodiments discussed herein;

FIGS. 5-6 are enhanced images illustrating an example fiber assembly once the fiber has been welded to a substrate, in accordance with some embodiments discussed herein;

FIG. 7 is a transmission electron microscope (TEM) image illustrating an example coating resting on a substrate before laser processing, in accordance with some embodiments discussed herein;

FIG. 8 is a TEM image illustrating the substrate of FIG. 7 after laser processing, with the coating material being integrated into the substrate, in accordance with some embodiments discussed herein;

FIG. 9 is a plot illustrating the intensity of signals at various angles for a fiber extending orthogonally relative to a substrate and for a fiber extending along a surface of a substrate, in accordance with some embodiments discussed herein;

FIG. 10 is a plot illustrating an example far-field profile for a fiber on a substrate comprising Corning EAGLE SG Slim Glass, with the substrate being welded using an ultraviolet laser and with the fiber extending orthogonally relative to a surface of the substrate, in accordance with some embodiments discussed herein;

FIG. 11 is a plot illustrating an example far-field profile for a fiber on a substrate comprising Corning EAGLE SG Slim Glass, with the substrate being welded using an ultraviolet laser and with the fiber extending along a surface of a substrate, in accordance with some embodiments discussed herein;

FIG. 12 is a plot illustrating the amount of absorption due to the presence of different metal coating, in accordance with some embodiments discussed herein;

FIG. 13 is a block diagram illustrating various components of a system for laser welding a fiber to a substrate, in accordance with some embodiments discussed herein; and

FIG. 14 is a flow chart illustrating an example method for laser welding a fiber to a substrate, in accordance with some embodiments discussed herein.

### DETAILED DESCRIPTION

Example embodiments now will be described more fully hereinafter with reference to the accompanying drawings, in which some, but not all embodiments are shown. Like reference numerals generally refer to like elements throughout. For example, reference numbers 114, 114′, 114″, 414, and 514 are each used for substrates. As used herein, photonic energy and light are intended to be used interchangeably. Additionally, any connections or attachments may be direct or indirect connections or attachments unless specifically noted otherwise.

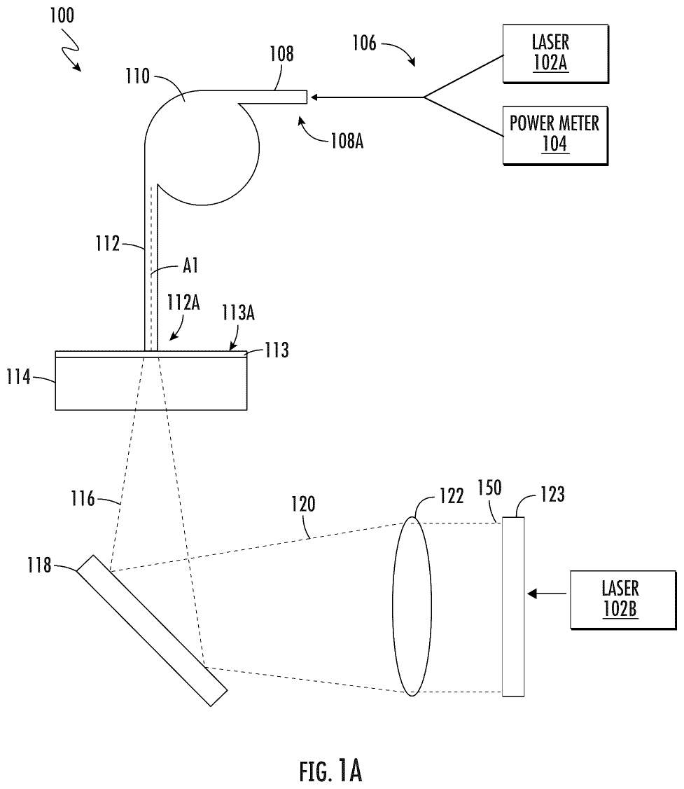

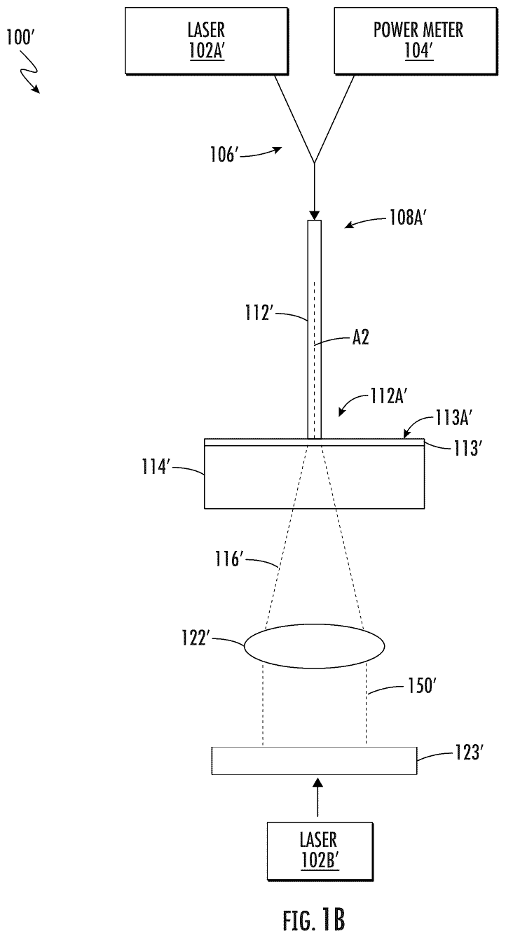

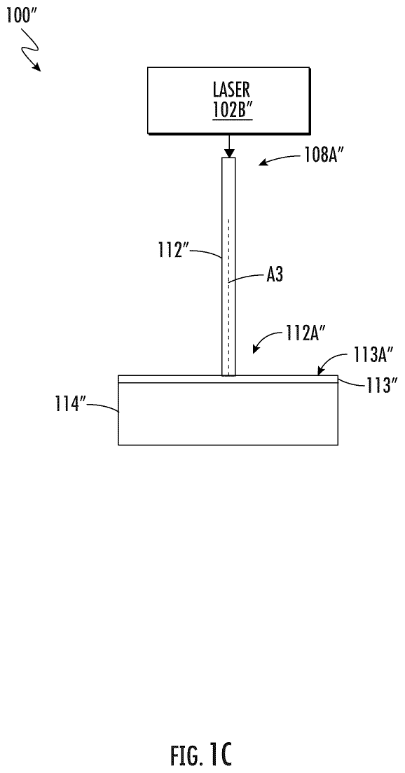

FIG. 1A is a schematic view illustrating an example system 100 for welding a fiber to a substrate 114. The system 100 comprises a laser 102A and a laser 102B. The lasers 102A, 102B are ultraviolet lasers. The laser 102A may operate at a wavelength of about 1310 nanometers or about 1550 nanometers with a few megawatts of power in a continuous wave mode, and the laser 102B may operate at a wavelength of about 355 nanometers with a frequency of about 2 megahertz. The laser 102B may also generate photonic energy in pulses of about 10 nanoseconds in length, about 5 nanoseconds in length, or about 2 nanoseconds in length. The laser 102B and other lasers described herein may be high repetition ultraviolet lasers, and the use of such lasers may be critical as they generate enough absorption in the metal coating and surrounding glass without ablation of the material characteristics that may be accomplished using a nanosecond pulsed laser with a low repetition rate of less than 100 megahertz. However, other lasers may be utilized that operate at a different wavelength, a different frequency, and/or at a different pulse length. Alternatively, lasers may be continuous wave lasers that provide photonic energy continuously when active rather than providing photonic energy in pulses. The laser 102A may be attached to a coupler 106 alongside a power meter 104, which will be discuss further herein. Laser 102B may typically operate at only a few Watts of average power.

In FIG. 1A, a fiber is provided including a first fiber portion 108, a second fiber portion 112, and another fiber portion that is positioned in fiber reel 110. However, in other embodiments, the fiber reel 110 may be omitted, and the fiber may extend in different directions. The fiber of FIG. 1A and other fibers described herein may be telecommunications fibers or optical fibers. A first end 108A of the fiber is positioned at the end of the first fiber portion 108, and a second end 112A of the fiber is positioned at the end of the second fiber portion 112.

The system 100 also comprises a substrate 114. The substrate 114 may comprise a material having a lower melting temperature than silica, and the substrate 114 may comprise fused silica in some embodiments. The substrate 114 may be a lens arrays, single focusing lenses, C-lenses, or some other type of optical element. While substrate 114 is generally flat, laser welding techniques described herein may still be utilized with other substrates that are not flat. A coating 113 is positioned on a surface of the substrate 114 between the second fiber portion 112 of the fiber and the substrate 114. This coating 113 may be an inorganic thin coating. Alternatively, the coating 113 may comprise a metal coating such as stainless steel or copper. The coating 113 may have a thickness of less than 100 nanometers or even less than 90 nanometers in some embodiments. In the illustrated embodiment, the coating 113 has a thickness of about 80 nanometers. The coating 113 may also be configured to absorb photonic energy at a wavelength of the laser 102B with at least 30 percent absorption.

The fiber defines a primary axis A1 at the second end 112A that is orthogonal to the surface of the substrate 114 and to the surface 113A of the coating 113 on the substrate 114. However, in other embodiments, the fiber may be positioned so that the second end 112A is not orthogonal to surface 113A.

The system 100 also includes a first optical element 118, a second optical element 122, and a third optical element 123. The first optical element 118 is a mirror, the second optical element 122 is a lens, and the third optical element 123 is a shutter. However, various other optical elements may be used in other embodiments. Additionally, no optical elements may be used in other systems, or a different number of optical elements may be used.

During operation, photonic energy from laser 102B is utilized to deform the coating 113. When laser 102B is activated, some of the photonic energy may be absorbed by the coating 113, and the coating 113 eventually becomes transparent for the photonic energy emitted by the laser 102B so that the photonic energy is allowed to extend through the coating 113. The coating 113 becomes transparent at the wavelength of the laser 102B (e.g., at a wavelength between about 300 nanometers and about 1700 nanometers).

When activated, the laser 102B emits photonic energy towards the optical element 123. The photonic energy emitted by the laser 102B may have a higher power level than the photonic energy emitted by laser 102A. For example, laser 102A may operate at a power level of less than about 1 megawatt, and laser 102B may operate at a power level of more than about 100 megawatts. Photonic energy passes through the optical element 123 and extends along optical path 150 towards the optical element 122. The optical element 122 directs photonic energy passing along optical path 150 so that the photonic energy begins to travel along optical path 120. The optical element 122 focuses the photonic energy to achieve higher power densities required to melt the coating 113 and/or the substrate 114. The photonic energy travelling along optical path 120 then extends to optical element 118. The optical element 118 then directs photonic energy passing along optical path 120 so that the photonic energy begins to travel along optical path 116. Photonic energy travelling along optical path 116 is directed through the substrate 114 so that the photonic energy reaches the coating 113. A portion of this photonic energy may be absorbed by the coating 113, especially when laser welding has not been completed. As more photonic energy is absorbed by the coating 113, the coating 113 becomes more transparent to allow more photonic energy to pass through the coating 113. The photonic energy emitted by laser 102B has a mismatch in numerical aperture value relative to the fiber, so this photonic energy causes minimal coupling at the fiber.

During operation, the laser 102A is generally used to provide low power photonic energy that is configured to be reflected back towards the power meter 104 to allow a determination of when laser welding has been completed. The laser 102A is activated, causing low power photonic energy to be directed from the laser 102A through the coupler 106. The coupler 106 is configured to direct photonic energy directly into the fiber at the first end 108A of the fiber. Once the photonic energy has been introduced into the fiber at the first end 108A, the photonic energy extends through the fiber until it exits at the second end 112A of the fiber. Upon exiting at the second end 112A of the fiber, photonic energy is directed to the coating 113. When laser welding has not been completed, a portion of the photonic energy from laser 102A may be absorbed by the coating 113 on the substrate 114, and another portion of the photonic energy from laser 102A may be reflected back into the fiber. Then, reflected photonic energy extends back through the fiber and to the coupler 106 so that the reflected photonic energy is directed to the power meter 104. The reflected signal received at the power meter 104 depends on refractive index difference between the fiber and component next to the second end 112A of the fiber. When laser welding is still not completed, the return signal may be about −14 decibels or higher. When laser welding is completed, then the return signal may be less than about −35 decibels where the substrate 114 comprises Corning EAGLE SG Slim Glass, or the return signal may be less than about −55 decibels where the substrate 114 comprises silica. However, the return signals may differ further where the substrate 114 comprises other materials. When laser welding is completed, the coating 113 is made more transparent, allowing more photonic energy to be emitted through the coating and causing less photonic energy to be reflected back to the power meter 104. Thus, when laser welding is completed, the return signals received at the power meter 104 are lower.

The coupler 106 may be a three decibel coupler, and the power meter 104 may be configured to monitor the return signal by measuring the amount of photonic energy returning through the fiber. The attachment of the fiber and the substrate may be controlled by a return signal at the power meter 104. When the return signal at the power meter 104 drops below around −20 to −30 decibels, it may be determined that laser welding is completed for the fiber, and the lasers may be turned off or may be advanced to another fiber. The return signal may be impacted by reflection from a back surface of the substrate, and the return signal may also be impacted by an index mismatch between the fiber, the coating, and the substrate material. While coating 113 is illustrated as being spread across the entire top surface of the substrate 114 in FIG. 1A, the coating 113 may alternatively be positioned at smaller portions of the surface of the substrate 114 in other embodiments. While power meter 104 is utilized in the illustrated system 100 of FIG. 1A, the power meter may be omitted from other embodiments. Alternatively, power meter 104 may be used to determine the appropriate amount of photonic energy that needs to be emitted for one fiber, and a laser may subsequently emit the determined amount of photonic energy for other fibers without using a power meter 104.

Other alternative layouts may be used to form systems like the one illustrated in FIG. 1A. For example, an alternative system 100′ is illustrated in FIG. 1B. Similar to the system 100 of FIG. 1A, the system 100′ comprises a laser 102A′, a laser 102B′, a power meter 104′, a coupler 106′, a fiber 112′ having a first end 108A′ and a second end 112A′, a coating 113′, a substrate 114′, an optical element 122′ in the form of a lens, and another optical element 123′ in the form of a shutter. Each of these components may generally be similar to the corresponding elements of FIG. 1A.

During operation, photonic energy from laser 102B′ is utilized to deform the coating 113′. When laser 102B′ is activated, some of the photonic energy may be absorbed by the coating 113′, and the coating 113′ eventually becomes transparent for the photonic energy emitted by the laser 102B′ so that the photonic energy is allowed to extend through the coating 113′. The coating 113′ may become transparent at the wavelength of the laser 102B′ (e.g., at a wavelength between about 300 nanometers and about 1700 nanometers).

When activated, the laser 102B′ emits photonic energy towards the optical element 123′. The photonic energy emitted by the laser 102B′ may have a higher power level than the photonic energy emitted by laser 102A′. Photonic energy may pass through the optical element 123′ and may extend along optical path 150′ towards the optical element 122′. The optical element 122′ directs photonic energy passing along optical path 150′ so that the photonic energy begins to travel along optical path 116′. The optical element 122′ focuses the photonic energy to achieve higher power densities required to melt the coating 113′ and/or the substrate 114′. The photonic energy travelling along optical path 116′ is directed through the substrate 114′ so that the photonic energy reaches the coating 113′. A portion of this photonic energy may be absorbed by the coating 113′, especially when laser welding has not been completed. As more photonic energy is absorbed by the coating 113′, the coating 113′ becomes more transparent to allow more photonic energy to pass through the coating 113′. The photonic energy emitted by laser 102B′ has a mismatch in numerical aperture value relative to the fiber 112′, so this photonic energy causes minimal coupling at the fiber 112′.

During operation, the laser 102A′ may also be activated, and photonic energy may be directed from the laser 102A′ through the coupler 106′ and into the fiber 112′ at the first end 108A′. The coupler 106′ may be configured to direct photonic energy directly into the fiber 112′ at the first end 108A′. Once the photonic energy has been introduced into the fiber 112′, the photonic energy may extend through the fiber 112′ until it exits at the second end 112A′ of the fiber 112′.

When laser welding has not been completed, a portion of the photonic energy from laser 102A′ may be absorbed by the coating 113′ on the substrate 114′, and another portion of the photonic energy from laser 102A′ may be reflected back into the fiber 112′. Then, reflected photonic energy extends back through the fiber 112′ and to the coupler 106′ so that the reflected photonic energy may be directed to the power meter 104′. The reflected signal received at the power meter 104′ depends on refractive index difference between the fiber and component next to the second end 112A′ of the fiber 112′. When laser welding is still not completed, the return signal may be about −14 decibels or lower. When laser welding is completed, then the return signal may be less than about −35 decibels where the substrate 114′ comprises Corning EAGLE SG Slim Glass, or the return signal may be less than about −50 decibels where the substrate 114′ comprises silica. However, the return signals may differ further where the substrate 114′ comprises different materials. When laser welding is completed, the coating 113 may be made more transparent, allowing more photonic energy to be emitted through the coating and causing less photonic energy to be reflected back to the power meter 104′. Thus, when laser welding is completed, the return signals received at the power meter 104′ may be lower.

The fiber 112′ defines a primary axis A2 at the second end 112A′, with the primary axis A2 being orthogonal to the surface of the substrate 114′ and to the surface 113A′ of the coating 113′ on the substrate 114′. However, in other embodiments, the fiber 112′ may be positioned so that the first end 108A′ is not orthogonal to surface 113A′. The system 100′ of FIG. 1B differs from the system 100 of FIG. 1A in that system 100′ does not include any fiber reel 110 and system 100′ only includes two optical elements. While coating 113′ is illustrated as being spread across the entire top surface of the substrate 114′ in FIG. 1B, the coating 113′ may alternatively be positioned at smaller portions of the surface of the substrate 114′ in other embodiments.

Another alternative system 100″ is illustrated in FIG. 1C. Similar to the system 100 of FIG. 1A and the system 100′ of FIG. 1B, the system 100″ comprises a laser 102B″, a fiber 112″ having a first end 108A″ and a second end 112A″, a coating 113″, a substrate 114″. The system 100″ of FIG. 1C differs from other systems in that the laser 102B″ is positioned on the side of the fiber 112″ rather than on the side of the substrate 114″, so any photonic energy generated by the laser 102B″ travels first through the fiber 112″ rather than through the substrate 112″. Additionally, the system 100″ is provided without any optical elements, without a second laser, without a coupler, and without a power meter.

During operation, the laser 102B″ may be activated. Photonic energy from the laser 102B″ is emitted directly into the first end 108A″ of the fiber 112″. This photonic energy extends through the fiber 112″ and out of the fiber 112″ at the second end 112A″ of the fiber 112″. When laser welding has not been completed, a portion of the photonic energy from laser 102B″ may be absorbed by the coating 113″ on the substrate 114″, and another portion of the photonic energy from laser 102A″ may be reflected back into the fiber 112″. In some embodiments, reflected photonic energy may extend back through the fiber 112″ and to a power meter attached via a coupler to measure the amount of reflected photonic energy so that the power meter may be used to determine when laser welding has been completed. However, in other embodiments, it may be determined that laser welding is completed in other ways (e.g., by activating laser 102B″ for a specified duration of time, by using other sensors, etc.).

The fiber 112″ defines a primary axis A3 at the second end 112A″, with the primary axis A3 being orthogonal to the surface of the substrate 114″ and to the surface 113A″ of the coating 113″ on the substrate 114″. However, in other embodiments, the fiber 112″ may be positioned so that the second end 112A″ is not orthogonal to surface 113A″. The configurations used for the system 100 of FIG. 1A, system 100′ of FIG. 1B, and system 100″ of FIG. 1C are merely exemplary, and it should be understood that various alternative configurations are also contemplated.

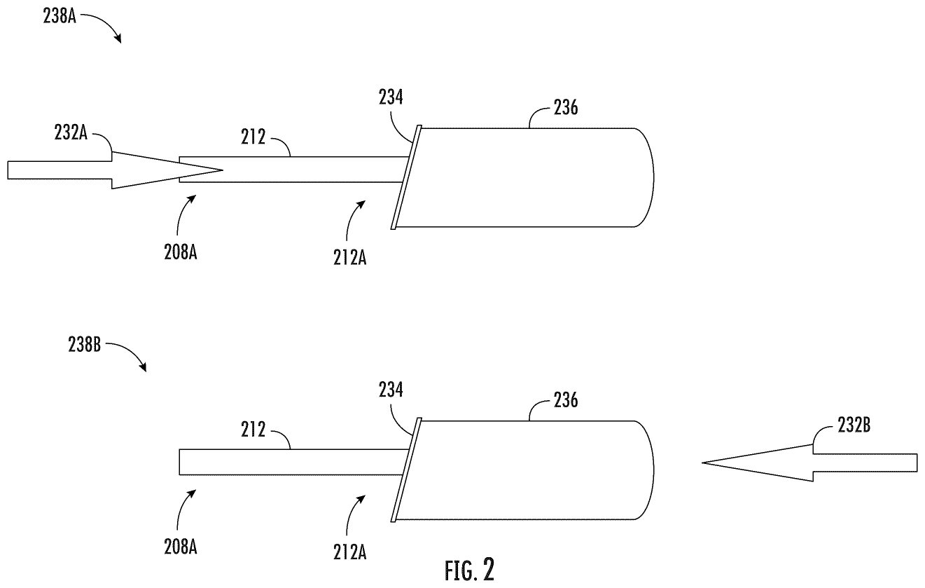

Laser welding may be used to attach a fiber to various types of substrates, and FIG. 2 illustrates two example fiber assemblies with a fiber being laser welded to a substrate in the form of a lens. The fiber assembly 238A includes a fiber 212 and a substrate 236, with coating 234 positioned between the fiber 212 and the substrate 236. The substrate 236 is a C-lens type device, but other types of lenses may be used in place of the substrate 236. Even with the substrate 236 not being flat, laser welding may still be performed effectively.

In the fiber assembly 238A of FIG. 2, photonic energy 232A may be emitted into the fiber 212 at a first end 208A of the fiber 212. By doing so, the photonic energy may travel through the fiber 212 and out of the fiber 212 at the second end 212A. This photonic energy may be partially absorbed at the coating 234 as described above.

As illustrated by fiber assembly 238B of FIG. 2, photonic energy 232B may also be emitted from the opposite direction, with photonic energy 232B travelling through a substrate 236 before reaching the coating 234. For both fiber assembly 238A and fiber assembly 238B, the wavelength of light may depend on the material used for the fiber 212, the coating 234, and/or the substrate 236.

Where substrate 236 comprises fused silica, ultraviolet photonic energy may be used with a wavelength of about 355 nanometers and with a high repetition rate radiation. For lower melting temperature glass materials, other wavelengths such as an infrared (IR) wavelength or near infrared (NIR) wavelengths may be suitable. Furthermore, for lower melting temperature glass materials, photonic energy may be either pulsed or may be provided in continuous waves. In the fiber assemblies 238A, 238B of FIG. 2, examples are provided where the fiber 212 does not extend perfectly orthogonally relative to a surface of the substrate 236, and the laser welding approaches described herein may still operate effectively with some deviation from a perfectly orthogonal orientation for the fiber 212.

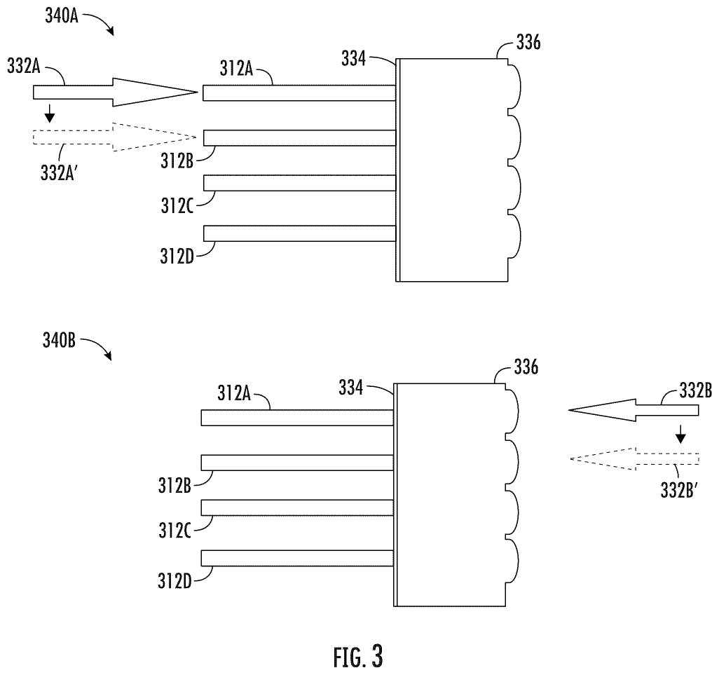

Similarly, photonic energy may be emitted through arrays of fibers to laser weld the fibers to a substrate, and these arrays of fibers may be densely packed. FIG. 3 illustrates two fiber assemblies 340A, 340B, with photonic energy being directed into fibers of the fiber assemblies 340A, 340B in different ways. In the fiber assembly 340A, an array of four fibers is provided, with the array including fibers 312A-312D. The fiber assembly 340A also includes a substrate 336 in the form of a lens array and coating 334 positioned between the substrate 336 and the fibers 312A-312D. The coating 334 may be provided in the form of a film. The substrate 336 may be a gradient-index (GRIN) lens attachment, but other lenses may be used in place of a GRIN lens attachment in other embodiments. Photonic energy may be emitted one-by-one through the fibers 312A-312D, with photonic energy first being emitted at position 332A. Photonic energy is emitted through the fiber 312A of the fiber assembly 340A in a manner similar to how photonic energy is emitted through the fiber 212 of the fiber assembly 238A in FIG. 2. Once it is no longer necessary to continue emitting photonic energy at fiber 312A, a laser may be shifted to position 332A′ to emit photonic energy at fiber 312B, and the laser may eventually be shifted to other positions to emit photonic energy to other fibers 312C, 312D in the fiber assembly 340A.

In the fiber assembly 340B, an array of four fibers is provided, with the array including fibers 312A-312D. The fiber assembly 340B also includes a substrate 336 in the form of a lens array and a coating 334 positioned between the substrate 336 and the fibers 312A-312D. Photonic energy may be emitted through the substrate 336 so that the photonic energy extends to the coating 334 at areas proximate to a respective fiber. Photonic energy is first emitted at position 332B. Photonic energy is emitted through the substrate 336 of the fiber assembly 340B in a manner similar to how photonic energy is emitted through the substrate 236 of the fiber assembly 238B in FIG. 2. Once it is no longer necessary to continue emitting photonic energy towards the coating 334 at a location proximate to fiber 312A, the laser may be shifted to position 332B′ to emit photonic energy towards the coating 334 at a location proximate to fiber 312B, and the laser may eventually be shifted to other positions to emit photonic energy towards the coating 334 at location proximate to other fibers 312C, 312D in the fiber assembly 340B. While the fiber assemblies 340A, 340B include linear arrays of fibers, other fiber assemblies may include two-dimensional arrays of fibers.

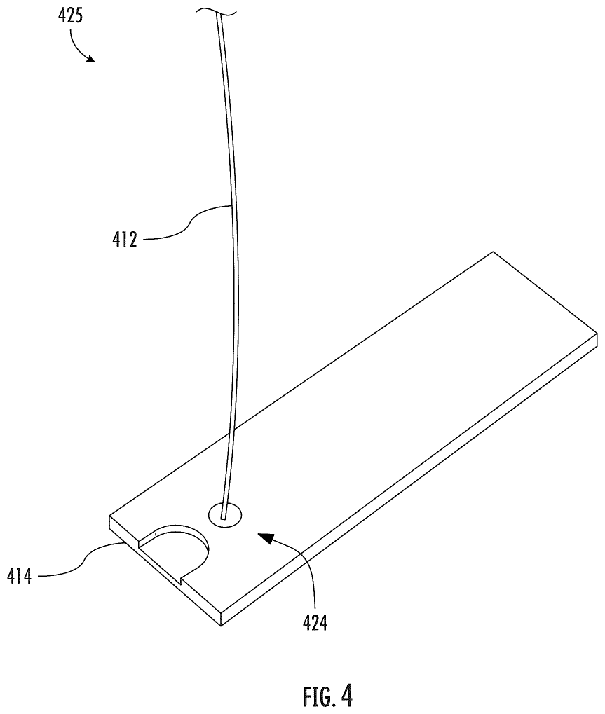

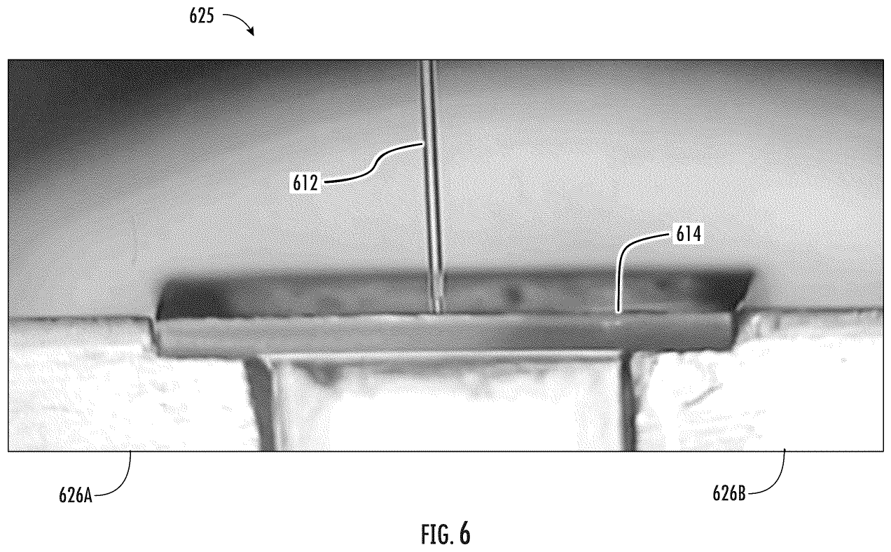

FIG. 4 is a perspective view illustrating a fiber assembly 425 once a fiber 412 has been laser welded to a substrate 414. The substrate 414 was formed by providing a glass substrate with a stainless steel coating having a thickness of about 40 nanometers positioned on the surface of the glass substrate. The initial glass substrate was a display glass in the form of Corning EAGLE SG Slim Glass, but other glass substrates may be used as well. Corning EAGLE SG Slim Glass comprises glass having a low melting temperature of around 800 degrees Celsius and a higher coefficient of thermal expansion of around 32×10⁻⁷/° C. Compared to substrates comprising fused silica, Corning EAGLE SG Slim Glass has a relatively low melting temperature and a relatively high coefficient of thermal expansion. These properties may allow the Corning EAGLE SG Slim Glass to undergo less distortion in comparison to other substrates comprising fused silica. Additionally, Corning EAGLE SG Slim Glass may be welded using less power than the power required to weld using substrates comprising fused silica due to the differences in coefficients of thermal expansion and melting temperatures. Where Corning EAGLE SG Slim Glass is used, the power levels may be around 1 to 1.5 watts, and the total time exposure may be about 0.5 seconds. Because more power is required for welding with fused silica substrates, an increased likelihood exists that distortion will be created in the fiber and/or in the substrate. However, substrates comprising fused silica may still be used in some embodiments (see, e.g., FIG. 6), and other materials may be used in place of Corning EAGLE SG Slim Glass.

In some embodiments, the fiber assembly 425 may include adhesive 424 around the fiber 412. This adhesive 424 may be introduced after the fiber 412 has been bonded to the substrate 414 through laser welding. By doing so, the adhesive 424 may not be positioned in any optical path of the fiber 412. The bonding between the fiber 412 and the substrate 414 is strong enough to allow the substrate 414 to be lifted using the fiber 412. Laser welding of fibers to substrates may be performed to accomplish good optical contact between the center of the fiber and substrate.

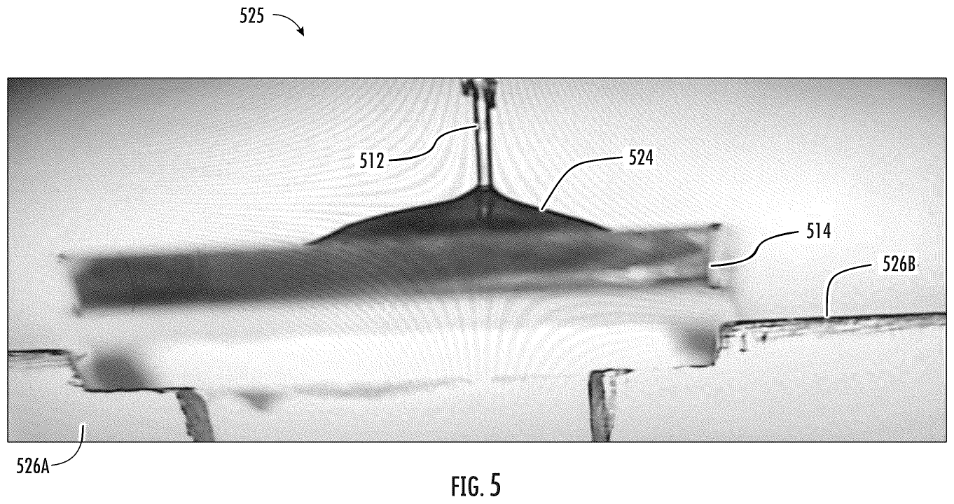

Another example fiber assembly 525 is illustrated in the enhanced image of FIG. 5, with the fiber assembly 525 including a fiber 512 that has been welded to a substrate 514. The fiber assembly 525 may be positioned on supports 526A, 526B while the fiber 512 is being welded to the substrate 514 using photonic energy. However, the fiber 512 is being used to lift the substrate 514 upwardly from the supports 526A, 526B in FIG. 5. The fiber assembly 525 includes adhesive 524 around the fiber 512. The adhesive 524 is a Norland Optical Adhesive 61 type adhesive, which is ultraviolet curable, but other adhesives may be used as well. This adhesive 524 may be introduced after the fiber 512 has been bonded to the substrate 514 using photonic energy. By doing so, the adhesive 524 may not be positioned in any optical path of the fiber 512, allowing light to more effectively travel out of the fiber 512. The adhesive 524 also provides mechanical stability to the sample.

Another example fiber assembly 625 is illustrated in the enhanced image of FIG. 6, with the substrate 614 comprising fused silica. The fiber assembly 625 includes a fiber 612 that has been welded to the substrate 614. The fiber assembly 625 may be positioned on supports 626A, 626B while the fiber 612 is being welded to the substrate 614 using photonic energy. The fiber 612 is an SMF-28 Ultra Corning fiber. However, other fiber assemblies may comprise different materials within the substrate and the fiber. To optimize the fiber assembly 625, it may be beneficial to adjust the thickness of any coating on the substrate before undergoing laser welding. In the substrate 614 of FIG. 6, the initial coating had a thickness of about 80 nanometers and this coating may eventually form a metal seal within the substrate 614 after laser welding is conducted. Where fused silica is used in the substrate 614, the power used at a laser for welding may need to be increased to levels of around 2 to 3 watts, and the total time exposure may be about 0.5 seconds.

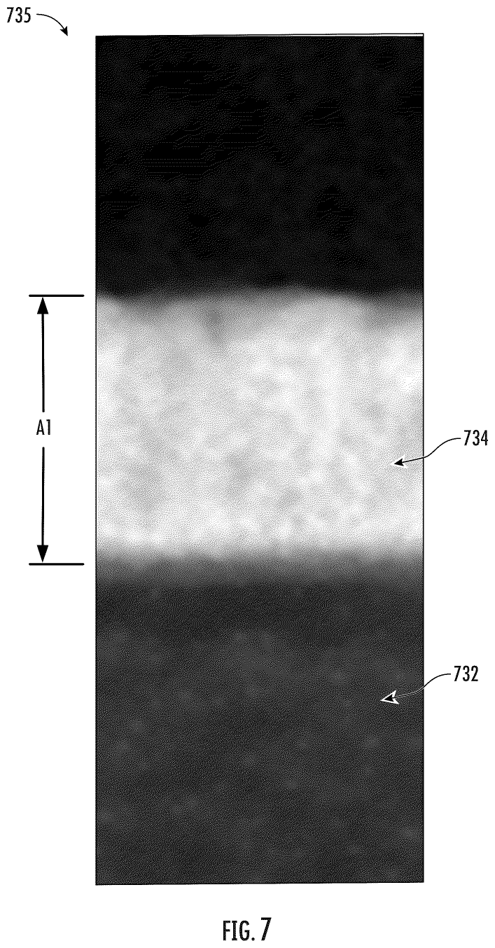

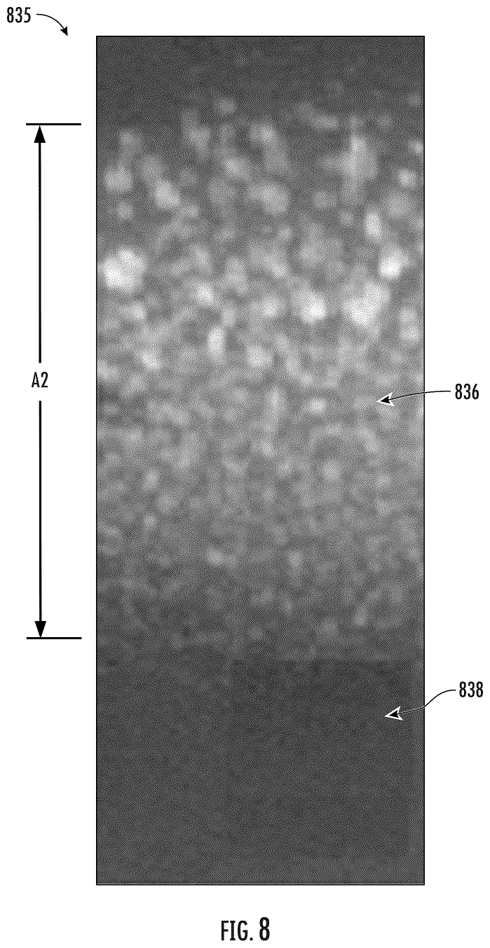

Laser welding may assist in forming a metal seal in a substrate by positioning a coating on the substrate and subjecting the coating to photonic energy. FIG. 7 is a TEM image illustrating example coated substrate 735 before laser welding, and FIG. 8 is a TEM image illustrating example coated substrate 835 after laser welding. Before laser welding, the coated substrate 735 includes a coating 734 positioned on a substrate 732. The coating 734 is a SS-304 stainless steel coating, but the coating 734 may be another metal coating such as another form of stainless steel copper in other embodiments. The coating 734 may be provided with an initial thickness A1 of about 20 nanometers, but other thicknesses may also be used for the coating 734 before laser welding. Other types of coating may alternatively be used. Similarly, the substrate 732 may comprise glass in some embodiments, but the substrate 732 may comprise other materials such as transparent materials.

After sufficient laser processing has been conducted, the material of the coating 734 may form a seal 836 within the substrate 838. By performing laser welding, the initial coating 734 is effectively shattered into nanoparticles having diameters well below 100 nanometers. These nanoparticles are effectively dissolved and migrated into the interfacial molten glass substrates during the dynamic welding dwell time. These nanodroplets in the welded area appear transparent to the eye since their size is well below the Mie scattering limit. The seal 836 that is formed may comprise metal material, and the seal 836 may be dispersed over a thickness A2 within the glass substrate 738. The thickness A2 may be about 250 nanometers in thickness in some embodiments, but the thickness A2 may possess other values.

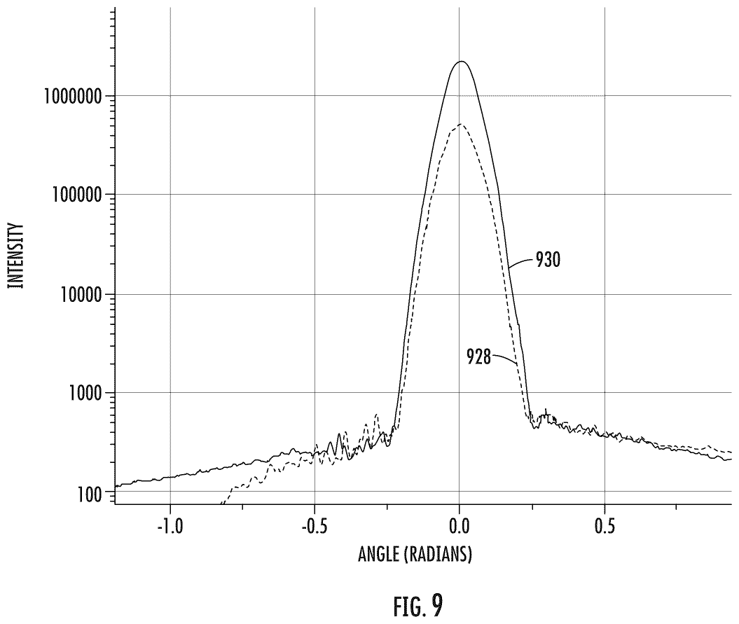

Even where fibers are laser welded so that they extend orthogonally relative to a substrate, the fibers only exhibit limited amount of distortion. FIG. 9 is a plot illustrating a far field image showing the intensity of signals at various angles for a fiber extending orthogonally relative to a substrate and for a fiber extending along a surface of a substrate. The far field images and profiles may be used to measure the intensity profile for an assembly after the laser welding process has been completed. In the plot, the intensities of signals are presented on the y-axis and the angle value is presented on the x-axis. Signal intensities may be obtained using a detector placed about 30 centimeters from a laser welded fiber assembly, with the design focus being a few millimeters. At a relatively large detector distance of about 30 centimeters, a collimated beam begins to show some divergence. The angles values are the angles that photonic energy extends in relative to a primary axis extending through a fiber. The shape of the far field profile corresponds to mode of the single mode fiber, and this is typically used to obtain a mode field diameter. However, any defects in the fiber or in the lens resulting from laser welding may cause distortion, and this distortion may lead to distortion of the far field profile. A far field profile without distortion would resemble a Gaussian two-dimensional distribution. When no lens is used, the divergence is typically high, and the fiber radiation output is nearly collimated when a lens is used. For plotlines 928, 930, a fiber is welded perpendicular to the substrate. However, measurements are performed in two different axes to evaluate the two-dimensional distribution of intensity. Where no distortion is present, the two-dimensional intensity distribution should be centered about 0 radians. For both plotlines 928 and 930, the wavelength was about 1550 nanometers. FIG. 9 illustrates limited distortion in the plotlines 928, 930 from a Gaussian distribution, revealing that limited the laser welding process caused limited distortion. Minimizing distortion is important to accomplish low insertion loss due to focus spot change when assemblies include a lensing device and pointing direction.

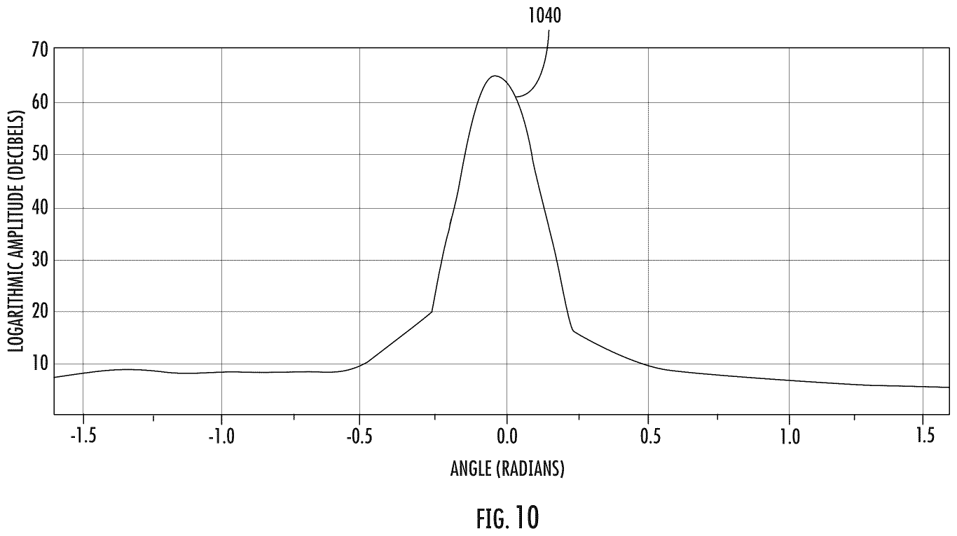

FIG. 10 is a plot illustrating an example far-field profile for a fiber on a display glass in the form of Corning EAGLE SG Slim Glass, with the fiber being welded using an ultraviolet laser in a vertical orientation. The plot of FIG. 10 displays the logarithmic amplitude in decibels on the y-axis and the angle in radians on the x-axis. The angles are angles that photonic energy extends in relation to a primary axis extending through a fiber. The plot of FIG. 10 includes a plotline 1040. This plotline 1040 generally remains around 8 decibels for angles up to about −0.6 radians. However the plotline 1040 begins increasing at a greater rate around an angle of −0.6 radians, with the plotline 1040 having a logarithmic amplitude of about 10 decibels around an angle of −0.5 radians, a logarithmic amplitude of about 20 decibels around an angle of −0.25 radians, and a logarithmic amplitude of about 55 decibels around an angle of −0.125 radians. The logarithmic amplitude peaked at about 63 decibels, with this logarithmic amplitude peaking at an angle only slightly below 0.0 radians. The plotline 1040 then begins rapidly decreasing, with the plotline 1040 having a logarithmic amplitude of about 40 decibels around an angle of 0.125 radians, a logarithmic amplitude of about 16 decibels around an angle of 0.25 radians, a logarithmic amplitude of about 10 decibels around an angle of 0.5 radians, and a logarithmic amplitude of about 7 decibels around an angle of 1.0 radians. The plotline 1040 generally shows minimal distortion from a Gaussian shape, indicating minimal distortion due to the laser process. This may help to ensure low insertion loss when lensed fibers are used.

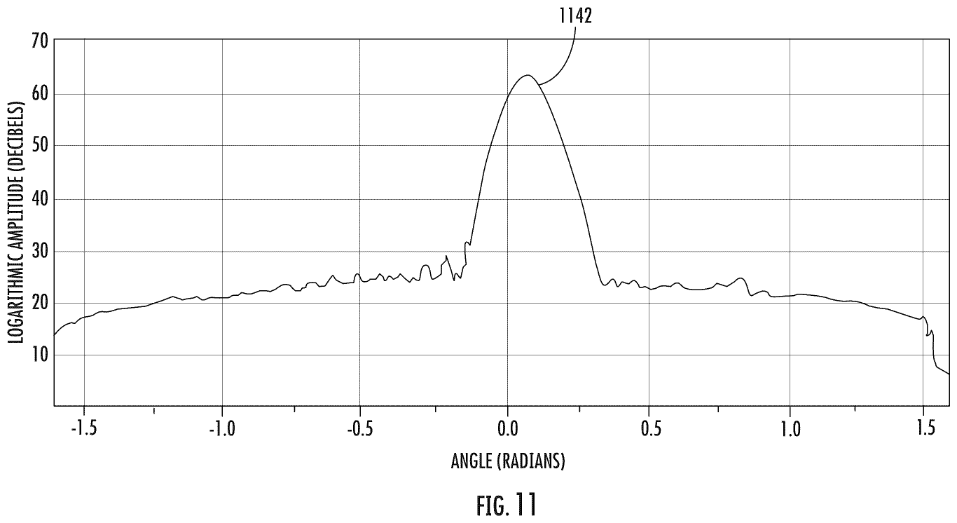

FIG. 11 is a plot illustrating an example far-field profile for a fiber on a display glass in the form of Corning EAGLE SG Slim Glass substrate, with the fiber being welded using an ultraviolet laser in a horizontal orientation. Similar to the plot of FIG. 10, the plot of FIG. 11 displays the logarithmic amplitude in decibels on the y-axis and the angle in radians on the x-axis. The angles are angles that photonic energy extends in relation to a primary axis extending through a fiber. The testing that resulted in the plot of FIG. 11 was done to verify the distortion from Gaussian distribution that was expected for an “unperturbed” fiber attached to a lens. The plot of FIG. 11 includes a plotline 1142. This plotline 1142 is around 17 decibels at an angle of −1.5 radians, the plotline 1142 gradually increases to a logarithmic amplitude of around 21 decibels at an angle of around −1.0 radians, and the plotline 1142 increases to a logarithmic amplitude of around 25 decibels at an angle of around −0.33 radians. The logarithmic amplitude then rapidly increases to a peak of about 63 decibels at an angle of around 0.10 radians, and the logarithmic amplitude then rapidly decreases to about 24 decibels at an angle of around 0.35 radians. The plotline 1142 then gradually decreases to a logarithmic amplitude of around 17 decibels at an angle of around 1.5 radians.

The typical insertion loss due to the presence of the substrate coating is less than about 0.1 decibels, so the coating is essentially transparent. Typical return loss due to reflection at the interface between a fiber and a silica substrate is less than about −55 decibels to about −60 decibels, and this indicates that both parts form optical contact with no index mismatch since the noise floor of the measurement is about −60 decibels.

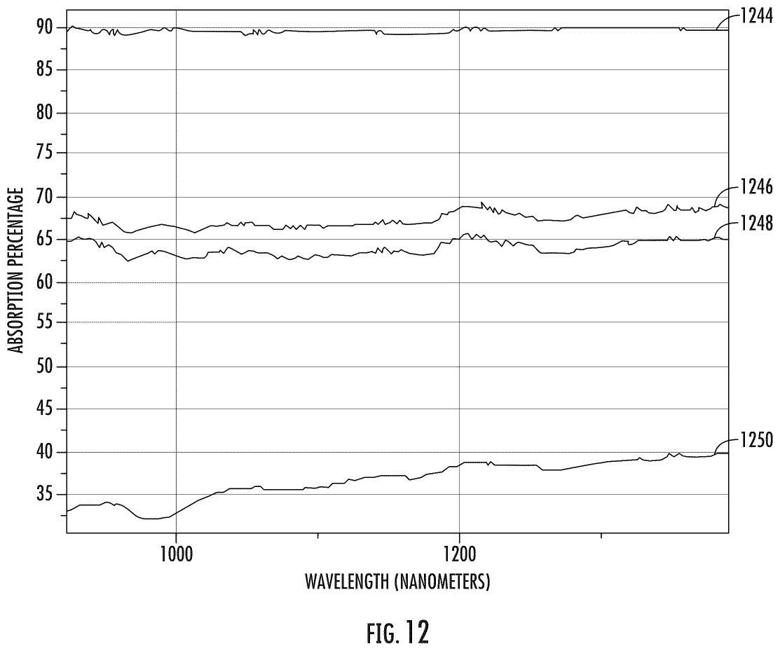

FIG. 12 is a plot illustrating the amount of absorption due to the presence of metal coating. For FIG. 12, the absorption percentage is illustrated on the y-axis and the wavelength is illustrated on the x-axis in nanometers.

Additionally, FIG. 12 shows four different plotlines. The plotline 1244 illustrates results where the initial coating comprises stainless steel. The plotline 1246 illustrates results where the initial coating comprises titanium. The plotline 1248 illustrates results where the initial coating comprises an alloy comprising nickel and aluminum. The plotline 1250 illustrates results where the initial coating comprises chromium, nickel, and oxygen.

As illustrated, plotline 1244 (for the initial coating comprising stainless steel) possessed the highest absorption percentage, with the absorption percentage remaining around 90 percent regardless of the wavelength. The plotline 1246 (for the initial coating comprising titanium) possessed the second highest absorption percentage, with the absorption percentage remaining between around 65 percent and 70 percent regardless of the wavelength. The plotline 1248 (for the initial coating comprising nickel and aluminum) possessed the third highest absorption percentage, with the absorption percentage remaining around 64 and with the absorption percentage for plotline 1248 being lower than the absorption percentage for plotline 1246 regardless of the wavelength. The plotline 1250 (for the initial coating comprising chromium, nickel, and oxygen) possessed the fourth highest absorption percentage, with the absorption percentage remaining between around 32.5 percent and 40 percent.

While the coating may comprise the material noted above, other materials may also be used in the coating. For example, coating may comprise chromium, titanium, aluminum, nickel, copper, and/or stainless steel, either alone or in combination. In some embodiments, coating may comprise a combination of stainless steel and aluminum, a combination of titanium and copper, or a combination of stainless steel and copper.

Coating may be provided with various thicknesses. For example, coating may be provided with a thickness between about 20 nanometers and about 150 nanometers, between about 40 nanometers and about 130 nanometers, between about 60 nanometers and about 110 nanometers, and between about 70 nanometers and about 90 nanometers. In various embodiments, coating having a thickness of around 80 nanometers may be used.

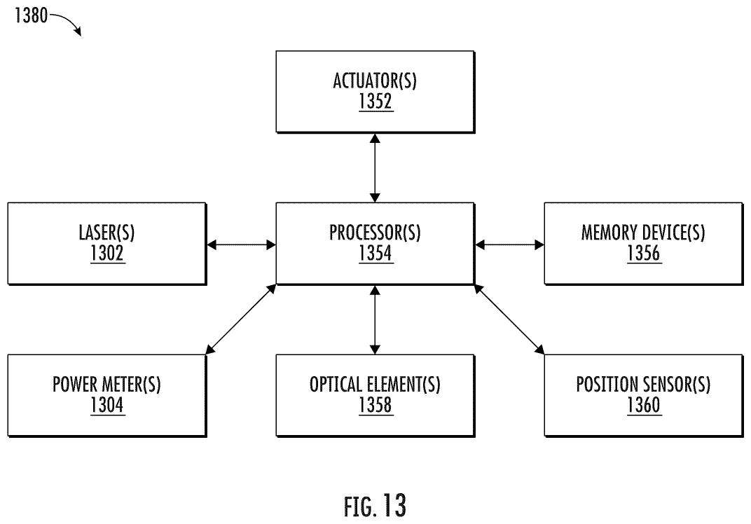

FIG. 13 is a block diagram illustrating example components of a system 1380 for welding a fiber to a substrate. The system 1380 includes one or more lasers 1302, one or more power meters 1304, one or more actuators 1352, one or more processors 1354, one or more memory devices 1356, one or more optical elements 1358, and one or more position sensors 1360.

The laser(s) 1302 may be ultraviolet lasers operating, for example, at a wavelength of about 355 nanometers, with a frequency of about 2 megahertz, and with the laser(s) 1302 generating photonic energy in pulses of about 2 nanoseconds in length. The laser(s) 1302 and other lasers described herein may be high repetition ultraviolet lasers, and the use of such lasers may be critical as they generate enough absorption in the metal coating and surrounding glass without ablation of the material characteristics that may be accomplished using a nanosecond pulsed laser with a low repetition rate of less than 100 megahertz. However, laser(s) 1302 may possess other forms and may operate at a different wavelength, a different frequency, and at a different pulse length. Alternatively, laser(s) 1302 may be continuous wave lasers that provide photonic energy continuously when active rather than providing photonic energy in pulses. Additionally, in some embodiments, the laser(s) 1302 may be configured to generate photonic energy in pulses, and the pulses may last 10 nanoseconds or less. The power meter(s) 1304 may be configured to monitor a return signal by measuring an amount of photonic energy returning through a fiber.

The optical element(s) 1358 may be used to redirect photonic energy into different directions so that photonic energy may be directed efficiently into a fiber. Optical element(s) 1358 may be provided in the form of a mirror, a lens, or a shutter, but other optical elements may also be used.

The actuator(s) 1352 may be utilized to adjust the position and/or orientation of one or more components. For example, if a different direction relative to the fiber for the photonic energy is desired, actuator(s) 1352 may be used to adjust the position and/or orientation of the fiber, of one or more optical elements 1358, of the laser(s) 1302, or other components. Position sensor(s) 1360 may also be utilized. Position sensor(s) 1360 may be used to detect a position and/or orientation of a fiber, a laser, an optical element, the power meter, etc. In some embodiments, actuator(s) 1352 may be utilized to adjust the position and/or orientation of a component based on measurements obtained by the position sensor(s) 1360.

The memory 1356 may include computer readable instructions stored in the memory 1356. These computer readable instructions may be provided in the form of computer code. When executed by the processor(s) 1354, the computer readable instructions may cause the processor(s) 492 to execute any of the methods described herein.

In an example embodiment, the memory 1356 may include one or more non-transitory storage or memory devices such as, for example, volatile and/or non-volatile memory that may be either fixed or removable. The memory 1356 may be configured to store instructions, computer program code, and other relevant data in a non-transitory computer readable medium for use, such as by the processor(s) 1354 to carry out various functions in accordance with example embodiments of the present invention. For example, the memory 1356 could be configured to buffer input data for processing by the processor(s) 1354. Additionally or alternatively, the memory 1356 could be configured to store instructions for execution by the processor(s) 1354.

The processor(s) 1354 may be any means configured to execute various programmed operations or instructions stored in a memory device (e.g., memory 1356) such as a device or circuitry operating in accordance with software or otherwise embodied in hardware or a combination of hardware and software (e.g. a processor operating under software control or the processor embodied as an application specific integrated circuit (ASIC) or field programmable gate array (FPGA) specifically configured to perform the operations described herein, or a combination thereof) thereby configuring the device or circuitry to perform the corresponding functions of the processor(s) 1354 as described herein.

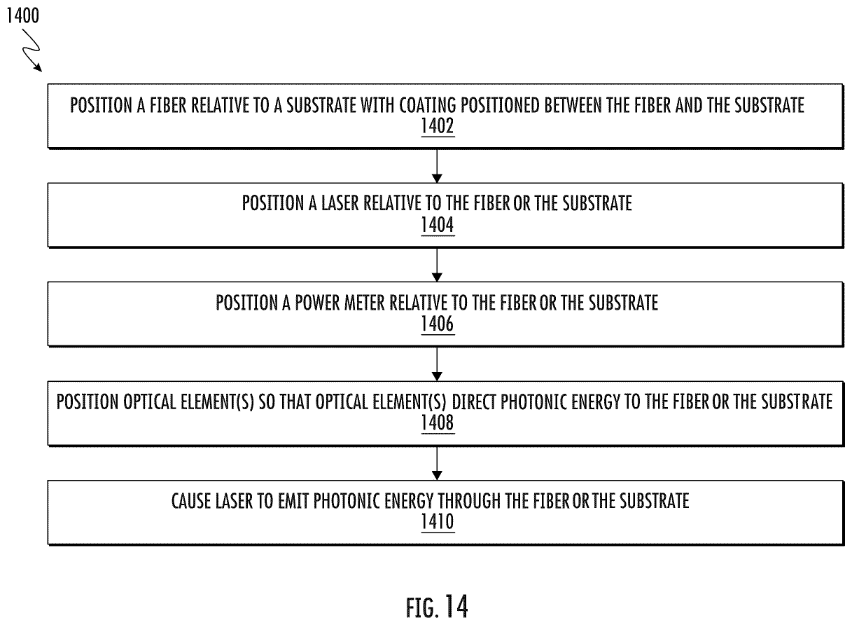

Methods for laser welding are also contemplated herein, and FIG. 14 is a flow chart illustrating an example method for laser welding a fiber to a substrate. At operation 1402, a fiber is positioned relative to a substrate with coating positioned between the fiber and the substrate. The fiber may be positioned so that a first end of the fiber is positioned proximate to a surface of the substrate with a coating positioned between the fiber and the substrate. The coating may be an inorganic thin coating or a metal coating having a thickness of, for example, less than 100 nanometers in some embodiments, and the coating may be configured to absorb photonic energy at a wavelength of the laser with at least 30 percent absorption. The coating may comprise a metal coating such as stainless steel or copper in some embodiments. The coating may be configured to become transparent at the wavelength of the laser after activation of the laser. The substrate may have a material with a lower melting temperature than silica in some embodiments. The substrate may comprise fused silica in some embodiments. In some embodiments, the fiber may be positioned relative to a substrate so that a primary axis of the fiber at the first end is orthogonal to the surface of the substrate.

At operation 1404, a laser is positioned relative to the fiber or the substrate. In some embodiments, the laser may be positioned proximate to a second end of the fiber, with the second end of the fiber being positioned away from the substrate. Where this is the case, the laser may emit photonic energy to the coating by emitting photonic energy from the laser to the second end of the fiber so that the photonic energy passes from the second end of the fiber, through the fiber, out of the first end of the fiber, and to the coating on the substrate. In other embodiments, the laser may be positioned proximate to the first end of the fiber and proximate to the substrate, with the laser being configured to emit photonic energy through the substrate and so that the photonic energy may be emitted to the coating. The laser may be an ultraviolet laser in some embodiments, and the laser may be configured to generate photonic energy in pulses. These pulses may last for 10 nanoseconds or less in some embodiments.

At operation 1406, a power meter is positioned relative to the fiber or the substrate. In some embodiments, the power meter may be positioned proximate to the laser, and a coupler may be used to couple the power meter and the laser to the fiber. However, in other embodiments, the laser may be positioned proximate to the first end of the fiber and the power meter may be positioned proximate to the second end of the fiber, or the laser may be positioned proximate to the second end of the fiber and the power meter may be positioned proximate to the first end of the fiber. The power meter may be configured to monitor an amount of photonic energy extending through the fiber. As noted herein, in some embodiments, a power meter may not be included. In some embodiments where a power meter is used, a second laser may be provided, with this second laser being configured to emit low power photonic energy that may be reflected back to the power meter. Additionally, in some embodiments where a power meter is used, the power meter may only be used to determine the appropriate amount of photonic energy required for a first fiber, and the method may proceed by simply emitting the determined amount of photonic energy for each subsequent fiber.

At operation 1408, one or more optical elements may be positioned so that the optical element(s) direct photonic energy from the laser(s) to the fiber or the substrate. The optical element(s) may include a mirror, a lens, or a shutter, but other optical element(s) may also be utilized.

At operation 1410, emission of photonic energy by the laser through the fiber and/or the substrate is caused. Emission of the photonic energy through the fiber and the substrate causes the fiber to be laser welded to the substrate. Photonic energy may be emitted in an optical path, and there may be no epoxies or organic adhesives positioned within the optical path. By not including epoxy in the optical path, back-reflection signals may be minimized, the amount of degradation over time may be reduced, and environmental stability may be improved.

The method 1400 is merely exemplary, and the method 1400 may be modified in various ways. For example, the order of operations within method 1400 may be changed in other embodiments, and some of the operations may be performed simultaneously in some embodiments. Additionally, some of the operations of method 1400 may be omitted in some embodiments. For example, operation 1408 may be omitted in some embodiments. Additional operations may also be added to method 1400 in some embodiments.

### CONCLUSION

Many modifications and other embodiments set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. A method for laser welding a fiber to a substrate, the method comprising:
positioning a fiber relative to a substrate so that a first end of the fiber is positioned proximate to a surface of the substrate with a coating positioned between the fiber and the substrate;
positioning a laser relative to the fiber or the substrate; and
causing the laser to emit photonic energy through the fiber or through the substrate,
wherein emission of the photonic energy through the fiber or through the substrate causes the fiber to be laser welded to the substrate.

2. The method of claim 1, wherein the laser is an ultraviolet laser.

3. The method of claim 1, wherein emission of the photonic energy causes the coating to dissolve into the substrate and to become transparent at the wavelength of the laser.

4. The method of claim 1, wherein the laser is configured to generate photonic energy in pulses lasting about 10 nanoseconds or less.

5. The method of claim 1, wherein the fiber has a second end, wherein the laser is positioned proximate to the second end of the fiber, and wherein causing the laser to emit photonic energy through the fiber or through the substrate is performed by emitting photonic energy from the laser to the second end of the fiber.

6. The method of claim 1, wherein the laser is positioned proximate to the substrate, and wherein causing the laser to emit photonic energy through the fiber or through the substrate is performed by emitting photonic energy from the laser through the substrate so that the photonic energy then travels from the substrate to the first end of the fiber.

7. The method of claim 1, further comprising:
utilizing a power meter to monitor whether the laser welding has been completed.

8. The method of claim 7, further comprising:
a second laser configured to emit feedback photonic energy,
wherein the feedback photonic energy is directed towards the coating so that at least a portion of the feedback photonic energy is redirected to the power meter.

9. The method of claim 1, further comprising:
positioning at least one optical element so that the at least one optical element receives photonic energy from the laser and directs the photonic energy towards the fiber or the substrate.

10. The method of claim 9, wherein the at least one optical element includes at least one of a mirror, a lens, or a shutter.

11. The method of claim 1, wherein the fiber is configured to emit light out of the fiber and towards the substrate in an optical path, wherein no epoxies or organic adhesives are positioned within the optical path.

12. The method of claim 1, wherein the substrate has a material having a lower melting temperature than silica.

13. The method of claim 1, wherein the coating is an inorganic thin coating having a thickness of less than about 100 nanometers.

14. The method of claim 13, wherein the coating is configured to absorb the photonic energy at wavelength of the laser with at least about 30 percent absorption.

15. The method of claim 14, wherein the coating becomes transparent at the wavelength of the laser after activation of the laser.

16. The method of claim 1, where the coating is a metal coating.

17. The method of claim 16, wherein the coating comprises stainless steel or copper.

18. The method of claim 1, wherein the fiber is positioned relative to a substrate so that a primary axis of the fiber at the first end is orthogonal to the surface of the substrate.

19. A non-transitory computer readable medium for laser welding a fiber to a substrate, the non-transitory computer readable medium having stored thereon software instructions that, when executed by one or more processors, cause the one or more processors to:
position a fiber relative to a substrate so that a first end of the fiber is positioned proximate to a surface of the substrate with a coating positioned between the fiber and the substrate;
position a laser relative to the fiber or the substrate; and
cause the laser to emit photonic energy through the fiber or through the substrate, wherein emission of the photonic energy through the fiber or through the substrate causes the fiber to be laser welded to the substrate.

20. The transitory computer readable medium of claim 19, wherein the coating is an inorganic thin metal coating having a thickness of less than about 100 nanometers.

21.-25. (canceled)
